(19) United States
(12) Patent Application Publication
(10) Pub. No.: US 2007/0125648 A1
(43) Pub. Date: Jun. 7, 2007

(54) Sensor element for a sensor

(75) Inventors: Johann Riegel, Bietigheim-Bissingen (DE); Lothar Diehl, Gerlingen (DE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 10/571,869

(22) PCT Filed: Sep. 30, 2004
(86) PCT No.: PCT/EP04/52372

§ 371 Date: Jan. 19, 2007

(30) Foreign Application Priority Data
Oct. 9, 2003 (DE) 103 46 858.7

(51) Int. Cl. G01N 27/26

(52) U.S. Cl. 204/424

(57) ABSTRACT

A sensor element for a sensor for determining the concentration of a gas component in a gas mixture, in particular the oxygen concentration in the exhaust gas of internal combustion engines, has two electrodes which, together with a solid electrolyte, form a pump cell, and one of these electrodes is exposed to the gas mixture via a porous protective layer. The sensor element also has a reference electrode which is situated on the solid electrolyte and is exposed to a reference gas. One of the two electrodes, with a reference electrode and the solid electrolyte, forms a concentration cell or a Nernst cell. To make the measured values produced by the sensor element insensitive to pressure fluctuations in the gas mixture, the electrode surface of the second electrode facing away from the solid electrolyte is coated with a finely porous diffusion layer, which is directly exposed to the gas mixture, and the second electrode is used as the reference electrode of the Nernst cell. It is also provided that the porous protective layer may be configured as a coarsely porous diffusion layer, and either of the two electrodes may be used as a reference electrode of the Nernst cell.

### FIELD OF THE INVENTION

The present invention is directed to a sensor element for a sensor for determining the concentration of a gas component in a gas mixture, in particular the oxygen concentration in the exhaust gas of internal combustion engines.

### BACKGROUND INFORMATION

A known sensor element for a broadband lambda sensor (e.g., as described in published German patent document DE 199 41 051 has a sensor body composed of solid electrolyte layers in which a cavity or measuring chamber, connected to the exhaust gas via a diffusion barrier, and a reference gas channel exposed to a reference gas are formed. A pump cell for pumping oxygen into the cavity (rich exhaust gas) or from the measuring chamber (lean exhaust gas) includes an external pump electrode situated on the solid electrolyte body and covered by a porous protective layer, and an internal pump electrode situated in the cavity. A concentration cell or Nernst cell includes a measuring electrode or Nernst electrode situated in the measuring chamber and a reference electrode situated in the reference gas channel. The limit current flowing between the pump electrodes when a constant voltage, e.g., 450 mV, is applied to the Nernst electrode and the reference electrode is a measure of the lambda value of the exhaust gas. The sensitivity of this sensor element is set via the limit current determined by the diffusion barrier.

Such a sensor element exhibits a dynamic relationship with the pressure, i.e., the pressure peaks in the exhaust gas appear as output signals of the lambda sensor, although there is no causal relationship between the pressure peaks and the change in gas composition. This is explained by the fact that, when pressure pulses occur in the exhaust gas, an additional amount of exhaust gas is pushed into the cavity, which causes a brief increase in the positive or negative pump current intensity. In particular, in the case of a high oxygen concentration (lean exhaust gas) this fluctuation of the partial pressure in the cavity due to the incoming exhaust gas is very noticeable, and the amplitude of the fluctuations of the lambda sensor output voltage is proportional to the oxygen concentration, i.e., the pump current.

### SUMMARY

The sensor element according to the present invention has the advantage that, by omitting the measuring chamber and combining the pump electrode and Nernst electrode to form an electrode situated on the external surface of the solid electrolyte, and by designing the diffusion barrier as a finely porous diffusion layer directly covering the electrode, no additional gas mixture influx occurs upon a pressure increase in the gas mixture, which makes it possible to avoid measuring errors due to pressure fluctuations in the gas mixture. In contrast to the annular diffusion barrier in the conventional sensor element, the diffusion layer may be manufactured much more easily, and a layer structure may be implemented. A layer structure permits the inlet surface of the finely porous diffusion layer, for example, to have a somewhat coarsely porous design, which makes it resistant to contamination, for example, by oil ashes. The absence of a measuring chamber or cavity permits the gas inlet bore hole to be omitted and eliminates a heat conduction barrier which would otherwise promote cracking of the solid electrolyte. Situating the electrodes on the external surface of the solid electrolyte, i.e., on the two major surfaces of the sensor element, permits proper heat distribution.

If the porous protective layer on the first electrode is configured as a coarsely porous diffusion layer, the sensor element according to the present invention also has the advantage that the Nernst cell may optionally be formed by the first and'second electrodes. By this change of the reference electrode for the Nernst cell, i.e., using both the electrode coated with the finely porous diffusion layer and the electrode coated with the coarsely porous diffusion layer, two different limit currents may be implemented, making it possible to operate the sensor element in two different measuring ranges. For measurements requiring a low static dependence on pressure, the electrode coated with the coarsely porous diffusion layer is used as the reference electrode of the Nernst cell, while for measurements requiring low dynamic dependence on pressure and temperature, the electrode coated with the finely porous diffusion layer is used, for example, by applying 450 mV relative to the reference electrode. Finely porous is understood here as a diffusion layer in which a limit current in the range of 4 mA flows when the oxygen concentration in the measuring gas is 20%. Coarsely porous is understood as a diffusion layer in which a limit current in the range of 25 mA flows under the same circumstances.

The two measurements may be adjusted by changing the mode of operation. It is also possible to detect and compensate via adjustment the gas type sensitivity of the sensor element or its static dependence on pressure or temperature by measuring in both modes of operation.

According to an example embodiment of the present invention, both electrodes are situated on opposite sides of a solid electrolyte body. The solid electrolyte body is manufacturable in a very simple construction using two thick solid electrolyte sheets. According to an example embodiment of the present invention, one electrode is situated on each solid electrolyte sheet for this purpose. The two solid electrolyte sheets enclose an insulation layer having an integrated electric resistance heater between their surfaces facing away from the electrodes and are connected by this insulation layer and a solid electrolyte frame enclosing the insulation layer. To reduce the internal resistance between the two electrodes functioning as a pump cell, a solid electrolyte web passing through the insulation layer is formed between the two solid electrolyte layers.

### BRIEF DESCRIPTION OF THE DRAWINGS

FIG. 1 shows a cross-sectional view of a longitudinal section of a sensor element for a sensor for determining the concentration of a gas component in a gas mixture.

FIG. 2 shows a cross-sectional view of a section taken along line II-II in FIG. 1.

FIG. 3 shows a cross-sectional view of a longitudinal section along line III-III in FIG. 5 of a sensor element according to another exemplary embodiment.

FIG. 4 shows a cross-sectional view of a section along line IV-IV in FIG. 3.

FIG. 5 shows a cross-sectional view of a section along line V-V in FIG. 3.

### DETAILED DESCRIPTION

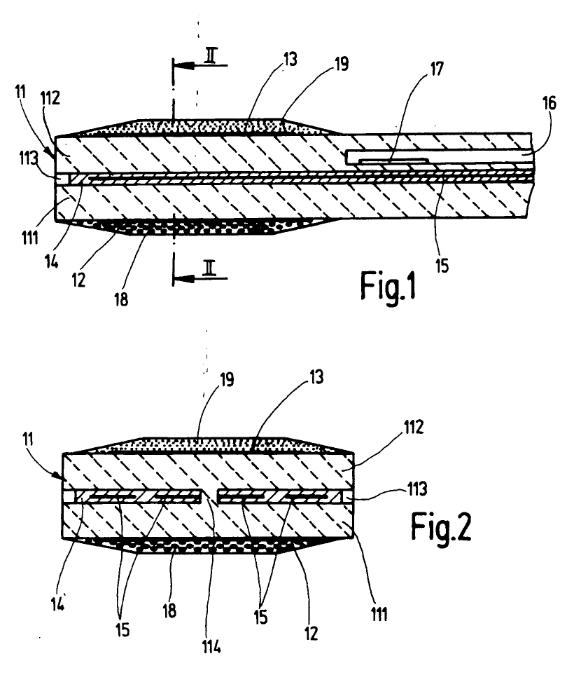

The sensor element schematically illustrated in FIGS. 1 and 2 in cross sections may be used for determining the concentration of a gas component in a gas mixture, in particular for a broadband lambda sensor for determining the oxygen concentration in the exhaust gas of an internal combustion engine. The sensor element has a solid electrolyte body 11, on whose opposite sides electrodes 12 and 13, respectively, are situated. Solid electrolyte body 11, made of yttrium-stabilized zirconium oxide (ZrO₂), for example, is composed of two thick solid electrolyte sheets 111, 112, which enclose an insulation layer 14 of aluminum oxide (Al₂O₃), for example, in which an electric resistance heater 15 is embedded. The two solid electrolyte sheets 111, 112 are connected via insulation layer 14 and a solid electrolyte frame 113 enclosing insulation layer 14. Furthermore, as FIG. 2 shows, there may also be a connection between solid electrolyte sheets 111, 112 via a solid electrolyte web 114 passing through insulation layer 14. A reference gas channel 16 is formed in solid electrolyte sheet 112 (upper solid electrolyte sheet in FIG. 1), which may be exposed to a reference gas, for example, air. A reference electrode 17 is applied to solid electrolyte 11 in reference gas channel 16.

One of two electrodes 12, 13 is mounted on each external surface of solid electrolyte sheets 111, 112 facing away from insulation layer 14. First electrode 12 situated on solid electrolyte sheet 111 (lower solid electrolyte sheet in FIG. 1) is coated by a coarsely porous diffusion layer 18, while second electrode 13 situated on solid electrolyte sheet 112 (upper solid electrolyte sheet in FIG. 1) is coated by a finely porous diffusion layer 19. Both electrodes 12, 13, covered by their particular diffusion layers 18, 19, are exposed to the gas mixture, e.g., to the exhaust gas in the case of the broadband lambda sensor. The two electrodes 12, 13 form a pump cell over which a limit current flows, which is a function of the concentration of a gas component, e.g., of the oxygen concentration in the case of the broadband lambda sensor. One of the two electrodes 12, 13 is optionally connected to reference electrode 17 as a reference electrode and forms with it a concentration cell or Nernst cell. To generate the limit current flowing in the pump cell and proportional to the concentration of the gas component, a constant DC current is applied to the Nernst cell, e.g., 450 mV. Since the two diffusion layers 18, 19 have different porosities, a different limit current is generated depending on which of the two electrodes 12, 13 is connected to reference electrode 17 as a reference electrode, so that it is possible to measure in two different measurement ranges using the sensor element.

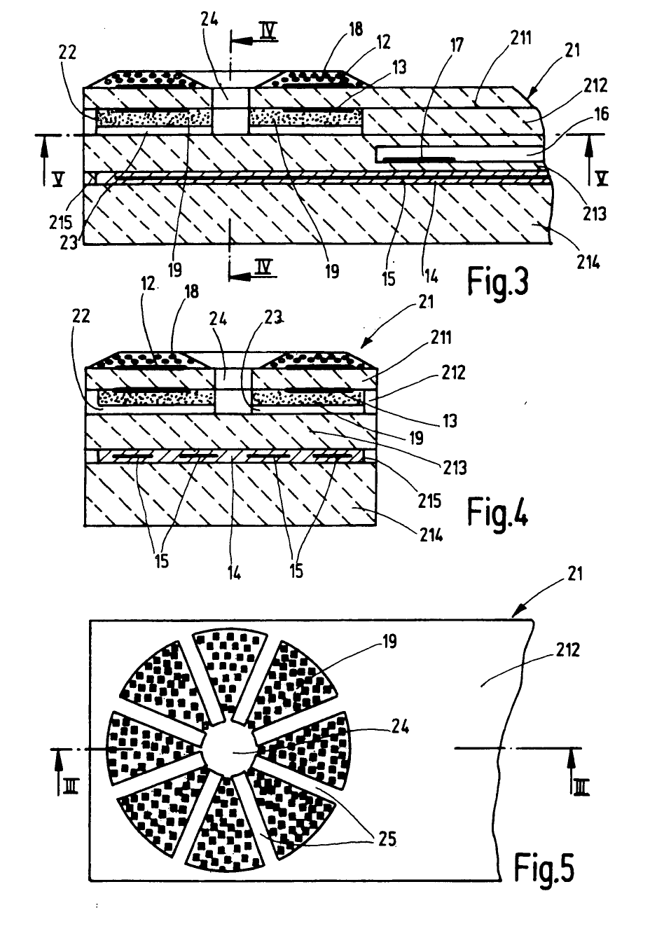

FIGS. 3 through 5 show an example embodiment of a sensor element in which the two electrodes 12, 13 are not distributed on the two opposite major surfaces of solid electrolyte body 21, but both electrodes 12, 13 are situated on the same half of the cross-sectional depth of solid electrolyte body 21. This is advantageous in certain applications because assembly in the bonding of electrodes 12, 13 is optimized.

Solid electrolyte body 21 is manufactured also in this case from solid electrolyte sheets or solid electrolyte layers in a layered structure. The two electrodes 12, 13 are situated on opposite sides of a first solid electrolyte layer 211. First solid electrolyte layer 211 is connected to a second solid electrolyte layer 213 via an intermediate layer 212, which is also made of a solid electrolyte. Intermediate layer 212 is provided with a recess 22, in which the electrode facing second solid electrolyte layer 213 and coated with its diffusion layer is situated. In the exemplary embodiment of FIG. 3, this is second electrode 13, coated with finely porous diffusion layer 19, but first solid electrolyte layer 211 may also be connected to second solid electrolyte layer 213 by first electrode 12, coated with coarsely porous diffusion layer 18, being situated in recess 22. In either case, it is provided that sufficient clearance 23 remains between diffusion layers 19, 18 and the surface of second solid electrolyte layer 213, this clearance always being filled with the gas mixture, i.e., the exhaust gas, via a gas supply orifice 24 in first solid electrolyte layer 211. Reference gas channel 16 is provided within second solid electrolyte layer 213, and reference electrode 17 is situated in reference gas channel 16. A substrate layer 214 below second solid electrolyte layer 213, which may also be made of solid electrolyte, encloses insulation layer 14 having resistance heater 15 embedded in it. In the exemplary embodiment of FIGS. 3 and 4, insulation layer 14 is enclosed by a solid electrolyte frame 215. To stabilize clearance 23 mechanically, first solid electrolyte layer 211 is supported by second solid electrolyte layer 213 within recess 22, specifically via radial webs 25, which support segments of diffusion layers 19, 18. Radial webs 25 are also made of a solid electrolyte and preferably form one piece with intermediate layer 212.

Also in this sensor element, diffusion layers 12, 13 may be made of multiple layers to set a limit current that may be carried by electrodes 12, 13. In the case of the finely porous diffusion layer 19, the upper layer facing away from second electrode 13, which forms the inlet surface of finely porous diffusion layer 13 for the gas mixture, i.e., the exhaust gas, may also be manufactured to be somewhat coarsely porous and therefore resistant to contamination, for example, by oil ashes.

1-9. (canceled)

10. A sensor element for a gas sensor for determining a concentration of a gas component in a gas mixture, comprising:
a pair of electrodes including a first electrode and a second electrode;
a solid electrolyte that forms, together with the first and second electrodes, a pump cell for the gas component;
a reference electrode provided on the solid electrolyte and exposed to a reference gas;
a porous protective layer for the first electrode, wherein the first electrode is exposed to the gas mixture via the porous protective layer, wherein the first electrode forms, together with the reference electrode and the solid electrolyte, a concentration cell; and
a finely porous diffusion layer coated on a surface of the second electrode facing away from the solid electrolyte, wherein the finely porous diffusion layer is directly exposed to the gas mixture, and wherein the second electrode functions as a reference electrode of the concentration cell.

11. The sensor element as recited in claim 10, wherein the porous protective layer is a coarsely porous diffusion layer.

12. The sensor element as recited in claim 11, wherein the solid electrolyte is part of a solid electrolyte body, and wherein the first and second electrodes are situated on opposite surfaces of the solid electrolyte body.

13. The sensor element as recited in claim 12, wherein the solid electrolyte body includes a first solid electrolyte sheet and a second solid electrolyte sheet, and wherein the first electrode is situated on the first solid electrolyte sheet and the second electrode is situated on the second solid electrolyte sheet, and wherein between a surface of the first solid electrolyte facing away from the first electrode and a surface of the second solid electrolyte facing away from the second electrode, the first and second solid electrolyte sheets substantially enclose an insulation layer having an integrated electric resistance heater, and wherein the first and second solid electrolyte sheets are interconnected by the insulation layer and a solid electrolyte frame laterally surrounding the insulation layer.

14. The sensor element as recited in claim 13, wherein a solid electrolyte web extending through portions of the insulation layer is provided between the first and second solid electrolyte sheets.

15. The sensor element as recited in claim 11, wherein the solid electrolyte is part of a solid electrolyte body that includes a first solid electrolyte layer and a second solid electrolyte layer, and wherein the first electrode and the second electrode are situated on vertically opposite sides of the first solid electrolyte layer, the first solid electrolyte layer being positioned relative to the second solid electrolyte layer in such a way that a clearance exists between the second solid electrolyte layer and the finely porous diffusion layer coated on the surface of the second electrode, and the clearance being exposed to the gas mixture via a gas supply orifice that extends through the first solid electrolyte layer.

16. The sensor element as recited in claim 15, wherein the first solid electrolyte layer is supported by a radial web on the second solid electrolyte layer, in the area of the clearance.

17. The sensor element as recited in claim 16, wherein the radial web is made of a solid electrolyte.

18. The sensor element as recited in one of claim 11, wherein the finely porous diffusion layer is made up of a plurality of superposed diffusion layers of different porosities.

19. The sensor element as recited in one of claim 12, wherein the finely porous diffusion layer is made up of a plurality of superposed diffusion layers of different porosities.

20. The sensor element as recited in one of claim 13, wherein the finely porous diffusion layer is made up of a plurality of superposed diffusion layers of different porosities.

21. The sensor element as recited in one of claim 15, wherein the finely porous diffusion layer is made up of a plurality of superposed diffusion layers of different porosities.

22. The sensor element as recited in one of claim 16, wherein the finely porous diffusion layer is made up of a plurality of superposed diffusion layers of different porosities.
